(19) United States
(12) Patent Application Publication
(10) Pub. No.: US 2005/0225062 A1
(43) Pub. Date: Oct. 13, 2005

(54) Integrated passenger airbag and instrument panel and assembly method

(76) Inventor: Conrad C. Dumbrique, Lake Orion, MI (US)

Correspondence Address: Sally J. Brown;AUTOLIV ASP, INC., 3350 Airport Road, Ogden, UT, 84405, US

(21) Appl. No.: 10/823,808

(22) Filed: Apr. 13, 2004

(51) Int. Cl. B60R 21/20

(52) U.S. Cl. 280/728.3; 280/732

(57) ABSTRACT

Instrument panels integrated with passenger airbag modules and methods of producing such modules are provided. The integrated instrument panels and passenger airbag modules of the invention provide modules that may be closely integrated with the instrument panel during its construction, thus simplifying attachment of the module to the instrument panel and rendering potential cost savings. The application also provides methods of construction and assembly of such integrated instrument panels and passenger airbag modules.

### BACKGROUND OF THE INVENTION

Safety belts are designed to protect the occupants of a vehicle during events such as automobile collisions. In low-speed collisions, the occupants are generally protected from impact with objects located inside the vehicle such as the windshield, the instrument panel, a door, the side windows, or the steering wheel by the action of the safety belt. In more severe collisions, however, even belted occupants may experience an impact with the car's interior. Airbag systems were developed to supplement conventional safety belts by deploying into the space between an occupant and an interior object or surface in the vehicle during a collision event. The airbag acts to decelerate the occupant, thus reducing the chances of injury to the occupant caused by contact with the vehicle's interior.

Many typical airbag systems consist of several individual components joined to form an operational airbag module. Such components generally include an airbag cushion, an airbag inflator, a sensor, and an electronic control unit. Airbag cushions are typically made of a thin, durable fabric that is folded to fit into a compartment of a steering wheel, dashboard, interior compartment, roof, roof rail, roof compartment, or other space in a vehicle. The airbag inflator is in fluid communication with the airbag cushion, and is configured to produce a gas to inflate the cushion when it is needed. The sensors detect sudden decelerations of the vehicle that are characteristic of an impact. The readings taken by the sensors are processed in the electronic control unit using an algorithm to determine whether a collision has occurred.

Upon detection of an impact of sufficient severity, the control unit sends an electrical signal to the inflator. The inflator uses one of many technologies currently known in the art to produce a volume of an inflation gas. The inflation gas is channeled into the airbag, inflating it. Inflation of the airbag causes it to deploy, placing it in a position to receive the impact of a vehicle occupant. After contact of the occupant with the airbag and the corresponding deceleration of the occupant, the airbag rapidly deflates. To accomplish this, the inflation gas is vented from openings in the airbag, deflating it and freeing the occupant to exit the vehicle.

As experience in the manufacture and use of airbags has increased, the engineering challenges involved in their design, construction, and use have become better understood. Most airbag systems are designed to rapidly inflate and provide a cushion in proximity to a vehicle occupant. Many such cushions are configured to be placed in front of a vehicle occupant. Placement of the cushions is determined based on presumptions made of the position occupied by a vehicle occupant in a vehicle during normal operation of the vehicle. Thus, a vehicle occupant enjoys optimal protection from a specific airbag when the occupant is in the presumed range of positions when the airbag deploys.

In some situations, injuries have been noted to occur when a vehicle occupant is “out of position” with regard to the presumed position discussed above. Some such injuries have been attributed to incidents in which vehicle occupants located out-of-position during the deployment of an airbag cushion are located in the path of the inflating cushion. Currently available airbag systems rapidly inflate a cushion in front of an occupant during a collision. This inflation process is generally difficult to regulate, however, and some regions of the cushion may inflate before others, increasing the risk of injury to out-of-position occupants located near these early-filling portions of the cushion.

Potential injury to out-of-position occupants could be reduced and/or avoided by the use of systems capable of causing full radial expansion of an airbag cushion prior to placement of the cushion in front of the vehicle occupant. Similarly, injury could be reduced by the use of systems capable of reducing the forward momentum with which an airbag cushion is directed toward a vehicle occupant. Some systems currently available to regulate cushion expansion and deployment often utilize passive tether systems such as “break-tethers”—tethers configured to first hold an airbag cushion at a specified state and then to rupture at a specified load to release the cushion and allow full cushion deployment. Although useful, such systems have proven complex, with a large number of variables present in configuring a break tether for a specific application, and a large number of variables which may affect the performance of the tethers. Other technologies utilize active tether systems which have several characteristics which may be actively controlled by systems of the vehicle. These technologies are also very complex and more expensive to implement and use in a vehicle.

Accordingly, a need exists for airbag deployment restraint devices for use in vehicles to regulate the deployment characteristics of an airbag cushion such that out-of-position vehicle occupants receive a more even load during inflation of the airbag cushion. It would be specifically beneficial to provide an airbag deployment restraint device capable of forcing the deploying airbag cushion to assume its fullest radial width prior to fully expanding toward a vehicle occupant, thus presenting a broad surface area for potential contact with the vehicle occupant. There is a similar need for devices capable of regulating the momentum with which an airbag cushion expands toward a vehicle occupant. It would be a further advantage in the art to provide such an airbag deployment restraint device that is compatible with existing airbag cushion and housing designs to avoid the costs associated with the customization of existing airbag modules. Such airbag cushion deployment restraint devices and methods for their use are provided herein.

### BRIEF SUMMARY OF THE INVENTION

The apparatus and method of the present invention have been developed in response to the present state of the art, and in particular, in response to the problems and needs in the art that have not yet been fully solved by currently available passenger airbag modules, instrument panels, and airbag module and instrument panel assembly methods. Thus, the present invention provides novel integrated passenger airbag and instrument panel assemblies and methods of their assembly for use in vehicles to protect a vehicle occupant during a collision event.

In one embodiment, the invention provides an airbag module for protecting a vehicle occupant. The airbag module first includes an airbag module cover. The airbag module cover has a substrate surface, an instrument panel adapter, and an airbag housing interlock. The airbag module cover of the invention is adapted to be integrated with an instrument panel substrate to provide a surface suitable for receiving a decorative overlay. The airbag module also includes an airbag module housing having an airbag case portion and an airbag module cover interlock portion. The module housing is adapted to be coupled to the airbag module cover. The airbag modules of the invention further include an airbag cushion configured to be deployed from the airbag module housing. In some specific embodiments of the invention, the airbag cushion is configured for use as a passenger airbag cushion.

According to the invention, the substrate surface of the airbag module cover may be configured to receive a decorative overlay such as a skin-and-foam overlay that may produce a class A surface suitable for use as an exposed surface in a vehicle. In some instances, the substrate surface of the inflatable airbag module may have a class A surface.

As discussed above, the airbag module cover of the inflatable airbag modules of the invention may include an instrument panel adapter. In some instances, the instrument panel adapter may simply comprise a surface of the module cover sized, shaped, and otherwise adapted to be attached to the instrument panel. In other embodiments of the invention, the instrument panel adapter may comprise a radial flange extending from the substrate surface of the airbag module cover.

The airbag module cover further includes an airbag housing interlock to allow the airbag module cover to be attached to an airbag module housing. In some configurations, the airbag housing interlock of the module cover may include a plurality of locking fingers projecting from the module cover. These locking fingers may be configured to extend into an airbag module cover interlock of an airbag module housing. Once in place, the locking fingers may function to securely join the module cover and the module housing for use in a vehicle.

The inflatable airbag module of the invention may also include a tear seam in the airbag module cover to allow proper deployment of the airbag cushion of the module. More specifically, the airbag module cover of the airbag modules of the invention may include a tear seam which may be invisible to a vehicle occupant from the exposed surface of the instrument panel housing the airbag cushion. In some instances, the tear seam may be placed in the airbag module cover during the construction of the cover itself. Such tear seams may be molded, stamped, or punched into the airbag module cover during its construction, after its construction, or even after its integration with the instrument panel. In some instances, the tear seam may be added to the airbag module after its integration with the instrument panel, and after a decorative overlay such as a skin-and-foam cover has been added. In one such embodiment, the airbag module cover may be scored using a laser to provide a proper tear seam. The depth of the scoring may be varied, as is known to one of skill in the art. In many instances, however, the laser-scoring completely penetrates the airbag module cover and may even extend into the decorative overlay to weaken it. In these ways, the tear seams provide an exit route for an inflating airbag cushion during cushion deployment in a collision event.

The invention further provides airbag module covers suitable according to the invention. As described as components of the module noted above, these airbag module covers of the invention have a substrate surface configured to receive a decorative overlay, an instrument panel adapter, and a plurality of locking fingers extending from the cover in a direction substantially opposite the substrate surface. As above, the substrate surface may be configured to receive a skin-and-foam overlay to provide a surface suitable for use in the interior of a vehicle, and the cover may be provided with a tear seam using the methods described above.

The invention may further include a vehicular instrument panel having an integral airbag module cover for use in a vehicle. Such dashboards may be constructed in a manner simpler than many methods currently in use, and may ease the installation of a passenger airbag cushion into a vehicle. Such instrument panels may first include a primary dashboard panel that provides the base structure for the instrument panel. The primary dashboard panel includes a substrate surface configured to receive a decorative overlay and an airbag module cover adapter. The substrate surface may be a class A surface, or it may be configured to receive an overlay providing a class A surface. The instrument panels next include an airbag module cover having a substrate surface configured to receive a decorative overlay, an instrument panel adapter, and an airbag housing interlock. The primary dashboard panel and the airbag module cover may be joined to provide a unitary instrument panel which may receive a decorative overlay such as a skin-and-foam overlay. Subsequent to the attachment of such an overlay, an airbag module may be attached to the locking fingers of the airbag module cover.

The primary dashboard panel may first include an orifice sized to receive the airbag module cover. The primary dashboard panel may further comprise an adapter channel having a depth sufficient to allow the airbag module cover to nest into the substrate surface of the primary dashboard panel without substantial outward protrusion into the space of the cabin of the vehicle. This may result in a combination substrate surface that is sufficiently even that the application of a decorative overlay results in a substantially even surface with no obvious seams. As above, the instrument panel adapter of the airbag module cover may comprise a radial flange extending from the substrate surface of the airbag module cover or a face of the module cover configured to be attached to an instrument panel.

These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partial perspective view of the interior of a vehicle including a partially-cutaway view of an integrated instrument panel and passenger airbag module according to the invention;

FIG. 2 is an isolated perspective view of the integrated instrument panel and passenger airbag module of FIG. 1 shown exploded to illustrate the relation of its components;

FIG. 3A is a cross-sectional view of the integrated instrument panel and passenger airbag module of FIG. 2 taken at line 3A-3A of FIG. 2;

FIG. 3B is a detail of the cross-sectional view of the integrated instrument panel and passenger airbag module of FIG. 3A;

FIG. 4A is a cross-sectional view of another integrated instrument panel and passenger airbag module taken from a perspective similar to that of FIG. 2 taken at line 3A-3A of FIG. 2;

FIG. 4B is a detail of the cross-sectional view of the integrated instrument panel and passenger airbag module of FIG. 4A;

FIG. 5A is a cross-sectional view of still another integrated instrument panel and passenger airbag module taken from a perspective similar to that of FIG. 2 taken at line 3A-3A of FIG. 2; and

FIG. 5B is a detail of the cross-sectional view of the integrated instrument panel and passenger airbag module of FIG. 5A.

### DETAILED DESCRIPTION OF THE INVENTION

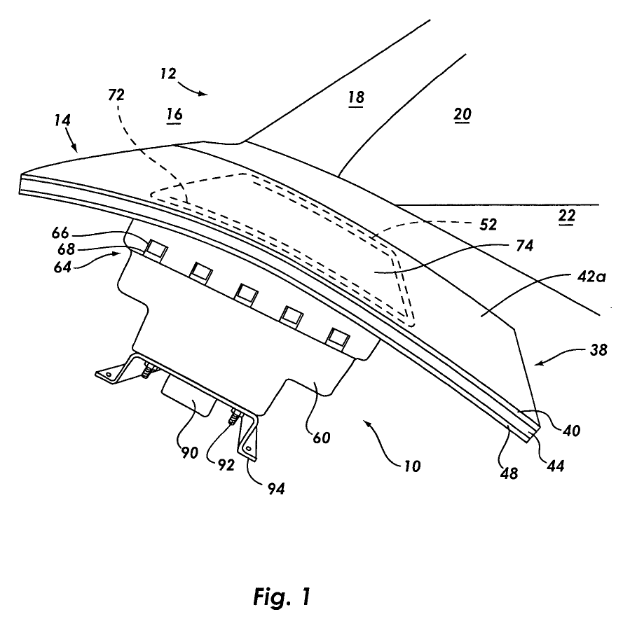

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the integrated passenger airbag and instrument panel and assembly method of the present invention, as represented in FIGS. 1 through 3B, is not intended to limit the scope of the invention, as claimed, but is merely representative of presently preferred embodiments of the invention.

Referring first to FIG. 1, a partial perspective view of the interior of a vehicle 12 is shown including a partially-cutaway view of an integrated instrument panel and passenger airbag module 10 according to the invention. A portion of the instrument panel 14 is shown with an integrated airbag module 10, along with a portion of the windshield 16, A-pillar 18, side door 22, and side window 20. The instrument panel 14 is shown to be composed of a plurality of layers, in this instance including a primary instrument panel substrate layer 48 and an associated airbag module cover 52 covered by a decorative overlay 38. Although many suitable decorative overlays 38 are known to one of ordinary skill in the art, the integrated airbag module 10 of FIG. 1 is shown to include a decorative overlay 38 taking the form of an instrument panel skin layer 40 and a foam layer 44.

The integrated airbag module 10 further includes an airbag module housing 60 for enclosing an inflatable airbag cushion such as a passenger-side airbag cushion (not shown). The module housing 60 is configured to be attached to a module cover 52 (shown in phantom) of the module 10 integrated with the instrument panel substrate layer 48 under the decorative overlay 38. In some embodiments of the integrated airbag module 10 of the invention, the housing 60 may be attached to the module cover 52 in a snap-fit fashion using at least one module lock 64. The module lock 64 may include locking fingers 66 extending from one of the components of the module 10, here the module cover. The module lock 64 may further include locking gates 68, here shown positioned on the module housing 60. The locking fingers 66 may specifically be configured to enter the locking gates 68 and be engaged such that the module cover 52 and housing 60 are held together. The module housing 60 further includes a contact surface 78 that is pressed against an outer substrate contact surface 58b of the substrate panel 48 during assembly of the module 10.

The integrated airbag module 10 may further include an airbag inflator 90 to provide inflation gas to the airbag cushion during deployment. In the airbag module 10 of FIG. 1, an airbag inflator 90 is shown linked to the module 10 by bracket 94 attached to the airbag module housing 60 by inflator attachments 92. The module 10 may be attached to a cross-vehicle beam by a bracket 94. Suitable inflators 90 may be mounted to the module 10 within the scope of the invention in a variety of ways known to one of ordinary skill in the art.

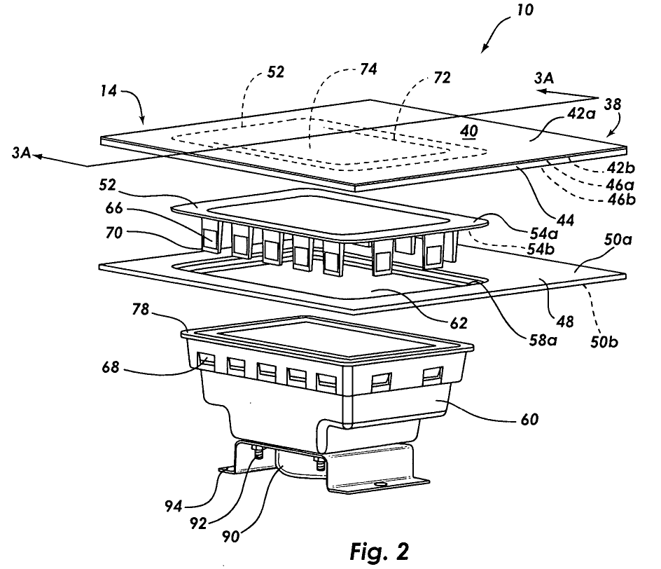

The individual components of the integrated airbag module 10 of the invention are also shown in FIG. 2 in which the integrated instrument panel and passenger airbag module 10 of FIG. 1 is shown isolated in a perspective view and partially exploded. In FIG. 2, the decorative overlay 38 has been separated from the upper surface 50a of the primary instrument panel substrate layer 48 and from the upper surface 54a of the airbag module cover 52. The decorative overlay 38 is shown to include a skin layer 40 having an upper surface 42a and a lower surface 42b. The upper surface 42a is generally a surface suitable for presentation in the cabin of the vehicle. Such high-quality surfaces are often referred to as “class A surfaces.” The lower surface 42b of the skin layer 40 is attached to a foam layer 44 of the decorative overlay 38. The foam layer 44 is optionally included in the overlay 38 to add depth and cushioning characteristics to the decorative overlay 38. The foam layer 44 has an upper surface 46a that is attached to the skin layer 40 and a lower layer 46b that attaches the decorative overlay 38 to the primary instrument panel substrate 48 and the airbag module cover 52.

The primary instrument panel substrate 48 and the airbag module cover 52 are configured to be joined to provide a substantially level upper face including the upper surface 50a of the substrate 48 and the upper surface 54a of the module cover 52. This presents a combined upper surface 50a, 54a suitable for receiving a decorative overlay 38 here shown to be a skin-and-foam overlay 38. Other decorative overlays 38 suitable for use with the present invention are known to one of ordinary skill in the art. As a result of this configuration, according to the invention, at least a portion of the airbag module 10 is joined to the instrument panel 14 during the assembly of the instrument panel 14. This results in a final module product 10 having a closely-integrated airbag module 10 and instrument panel 14.

More specifically, in the embodiment illustrated in FIGS. 1-2, at least a portion of the airbag module 10 such as the module cover 52 is placed into association with the primary substrate layer 48 prior to deposition of the decorative overlay 38. Following this, the decorative overlay 38, here foam and skin layers 44, 40 may be added over the top. This produces an integrally-linked instrument panel and airbag module assembly 10. The module housing 60 and other components of the module 10 may be attached to the module cover 52 after deposition of the decorative overlay 38. Alternatively, if convenient and practicable, the module housing 60 may be attached to the module cover 52 prior to the addition of the decorative overlay 38. As a result, the module housing 60 may be either present or absent during deposition of the decorative overlay 38, here comprising foam and skin layers 44, 40.

One factor that may be used in determining when the airbag module housing 60 is attached to the module cover 52 is whether or not the module cover 52 has been provided with a tear seam 72 configured to rupture on deployment of the airbag module 10 to permit the cushion 80 to escape the module 10. In some embodiments of the modules 10 of the invention, the tear seam 72 may be molded into the airbag module cover 52. In such modules 10, the module housing 60 may be attached to the airbag module cover 52 of the instrument panel 14 prior to addition of the decorative overlay 38. In such modules 10, the force of the deployment of the airbag cushion (not shown) is sufficient to rupture the tear seam 72 and sufficiently disrupt the decorative overlay 38 to provide for proper deployment of the airbag cushion.

In alternate embodiments of the modules of the invention, a tear seam 72 may be produced in the final module cover 52 and the associated decorative overlay 38 following deposition of the decorative overlay 38. In some circumstances, the tear seam 72 could be produced by using a laser to score the seam 72 into the cover 52. Alternatively, the tear seam 72 could be scored completely through the cover 52 and partially through the overlay 38 to further help assure proper egress of the deploying airbag cushion. Such scoring would generally not pass completely through the overlay 38. These methods would produce a hidden tear seam in the final integrated instrument panel and airbag module 10 that is functional, but not visible from the cabin of the vehicle 12. Laser scoring technology suitable for the practice of the invention is taught in U.S. Pat. No. 5,744,776.

As briefly described above, following attachment of the decorative overlay 38 to the combination of the instrument panel substrate 48 and the module cover 52, the airbag module housing 60 and the associated cushion 80 may be attached to the cover 52. In some embodiments of the invention, the module cover 52 and housing 60 are configured to allow their assembly in a snap-fit manner. More specifically, the module locks 64 may be configured to operate based on snap-fit principles. In some instances, this may simplify the assembly process and potentially reduce the labor and cost associated with assembly. Often, conventional assembly methods require hand-labor in attaching airbag modules using bolts or other labor-intensive fasteners. Use of snap-fit attachment structures in the module locks 64, although not required to be within the scope of the invention, may decrease labor costs and simplify the design of module components such as the module cover 52 and housing 60.

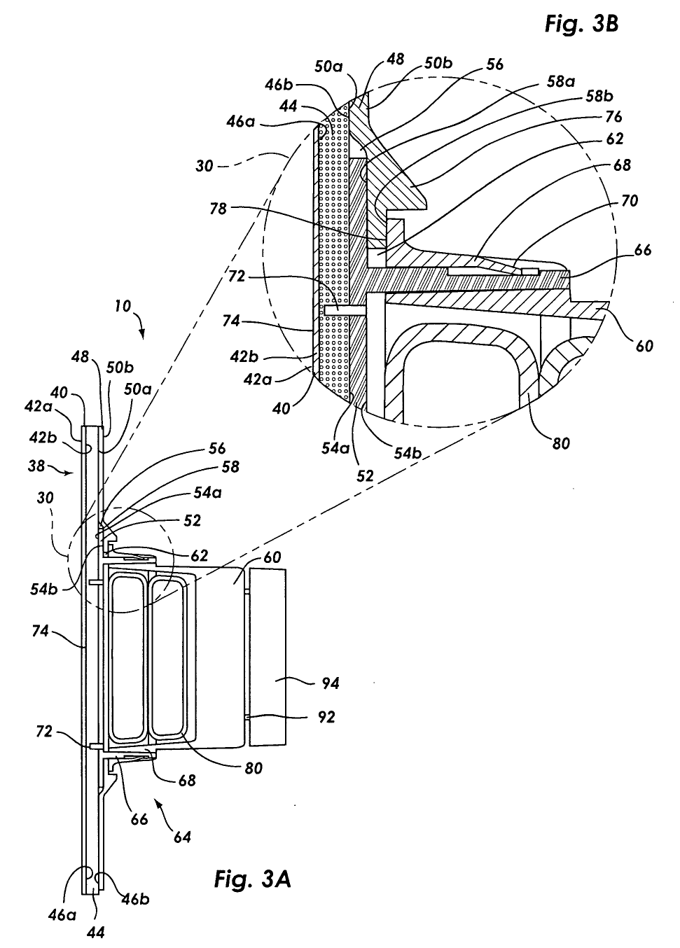

As briefly discussed above, the module locks 64 illustrated in FIGS. 1-3B include locking fingers 66 extending from the lower surface 54b of the module cover 52. As briefly mentioned above, the locking fingers 66 are configured to extend into the locking gates 68 present on the housing 60. As illustrated in FIGS. 3A and 3B, the locking fingers 66 are configured to enter the locking gates 68, and in some embodiments, to be engaged by biased locking clips 70. In some embodiments, the locking clip 70 may be an integral component of the locking gates 68. The specific structure and arrangement of the module locks 64 may be varied widely within the scope of the invention. In some embodiments of the invention, the module locks 64 may vary the position of the locking components, such as by placing locking fingers 66 on the module housing 60 and gates on the module cover 52. Similarly, the structure of the module locks 64 themselves may be varied within the scope of the invention as known to one of ordinary skill in the art.

FIG. 3A provides a cross-sectional view of the integrated instrument panel and passenger airbag module 10 of FIG. 2 taken at line 3A-3A of FIG. 2, and FIG. 3B provides a detailed view of a portion of this cross-sectional view indicated by the dashed circle 30 present in FIGS. 3A and 3B. FIG. 3A shows a cross-section of the module 10. The module 10 comprises a decorative overlay 38, an instrument panel substrate 48 integrated with an airbag module cover 52, and an airbag module housing 60. The module cover 52 and panel substrate 48 are configured to be placed together. More specifically, the panel substrate 48 has a substrate adaptor channel 56 having a size, depth, and shape configured to accommodate the module cover 52 and to provide a substantially flat combined surface. This is illustrated in detail in FIG. 3B. More specifically, the primary substrate panel 48 includes a substrate adaptor channel 56. The channel 56 has a contact surface 58a. This contact surface 58a is adapted to receive the module cover 52, with contact with the lower surface 54b of the module cover 52. The substrate panel 48 may additionally include an alignment ridge 76 projecting outwardly from the panel 48. Such a ridge 76 may operate to reduce movement of the airbag module housing 60, and may additionally assist in proper alignment of the components of the module 10 during assembly. The combined upper surfaces 50a, 54a of the substrate panel 48 and module cover 52 may then receive a decorative overlay 38 such as this one including a skin layer 40 and a foam layer 44.

As illustrated in FIGS. 3A and 3B, the substrate panel 48 includes an orifice 62. The orifice 62 is configured to be smaller than the module cover 52 such that the cover 52 cannot pass through it. It is, however, configured to allow portions of the module cover 52 to pass through it, including, but not limited to, elements of the module locks 64 such as locking fingers 66. As discussed above, the module 10 may be assembled by attaching the housing 60 to the assembled instrument panel substrate 48 and module cover 52. In doing so, a contact surface 78 of the module housing 60 is pressed against an outer substrate contact surface 58b of the substrate panel 48.

In this embodiment of the module 10 of the invention, the orifice 62 may also be used to provide access to the module cover 52 and decorative overlay 38 for the purposes of adding a tear seam 72, which may pass completely or partially through the cover 52, and potentially into the foam and skin layers 44, 40. As illustrated, the tear seam 72 has been cut completely through the cover 52 and partially into the foam layer 44, leaving the skin layer 40 intact. The overall shape of such a tear seam 72 may be varied widely within the scope of the invention as is known to one of skill in the art, but may include a substantially-U-shaped configuration to form a region of the module that will rupture to form an instrument panel flap 74 when the airbag cushion 80 deploys.

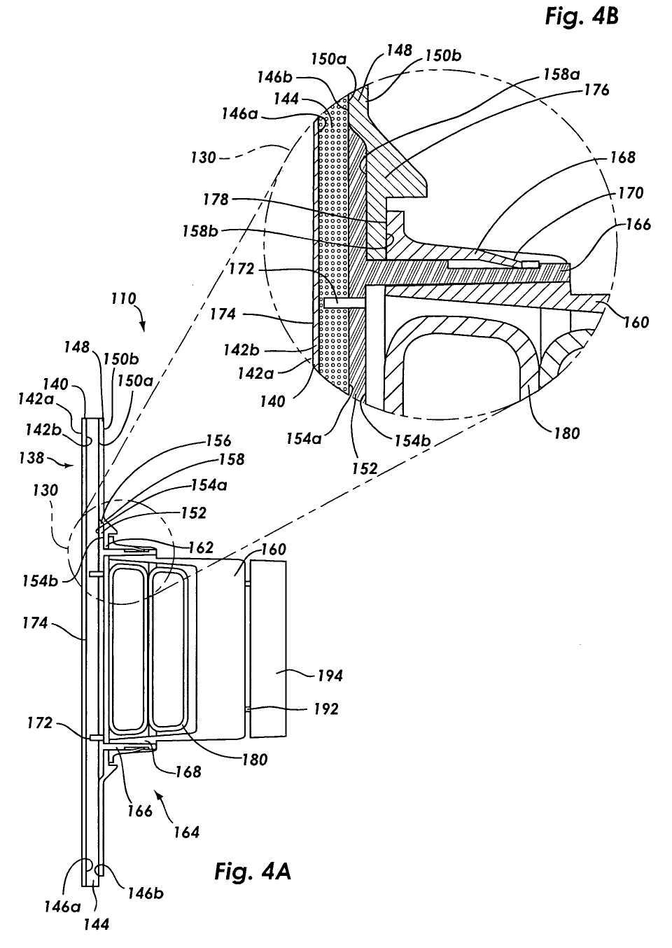

Referring next to FIG. 4A, yet another embodiment of the inflatable airbag modules 110 of the invention is shown. As in FIG. 3A, this Figure shows a cross-sectional view of this embodiment of the airbag module 110 is shown in a cross-sectional view taken from a perspective similar to that used to produce FIG. 3A, namely along a plane such as that defined by line 3A-3A of FIG. 2. FIG. 4B provides a detailed view of a portion of the cross-sectional view indicated by the dashed circle 130 present in both FIGS. 4A and 4B. The module 110 of FIG. 4A is in many respects similar to module 10 of FIGS. 3A and 3B. The module 110 first includes a decorative overlay 138, an instrument panel substrate 148 integrated with an airbag module cover 152, and an airbag module housing 160. In module 110, however, the module cover 152 and panel substrate 148 are produced and integrated using techniques such as injection molding. Such techniques allow the parts 148, 152 to be formed in an integrated manner. This may be done in a stepwise manner, i.e., one of the parts is first produced, and the second part is subsequently injection-molded in place. Alternately, this may be accomplished in a nearly simultaneous co-injection process that forms both parts 148, 152 in an integrated manner nearly simultaneously.

Thus, in FIGS. 4A and 4B, the panel substrate 148 of the module 110 conforms to the shape of the airbag module cover 152. While the module 10 of the previous Figures included an adaptor channel 56, the module 110 of FIGS. 4A and 4B instead includes a seam 158a at the interface of the upper surface 150a of the instrument panel substrate 148 and the lower surface 154b of the module cover 152. As in the previously-described embodiment, the substrate panel 148 may additionally include an alignment ridge 176 projecting outwardly from the panel 148. Similarly, as before, the combined upper surfaces 150a, 154a of the substrate panel 148 and module cover 152 may then receive a decorative overlay 138 such as this one including a skin layer 140 and a foam layer 144.

As previously discussed, the substrate panel 148 may be adapted to permit portions of the module cover 152 to extend therethrough. Structures such as elements of the locks 164, including locking fingers 166 may specifically be permitted to pass through the substrate panel 148. The resulting configuration allows the module 110 to be assembled by attaching the housing 160 to the unitary instrument panel substrate 148 and module cover 152 by allowing the locking fingers 166 to enter the locking gates 168 of the housing 160. The locking fingers 166 culminate with locking clips 170 that engage the locking gates 168. During assembly, a contact surface 178 of the module housing 160 is pressed against an outer substrate contact surface 158b of the substrate panel 148.

In this embodiment of the module 110 of the invention, the substrate panel 148 may also be adapted used to provide access to the module cover 152 and decorative overlay 138 for the purposes of adding a tear seam 172, which may pass completely or partially through the cover 152, and potentially into the foam and skin layers 144, 140. As illustrated, the tear seam 172 has been cut completely through the cover 152, disrupting the upper and lower surfaces 154a, 154b, and cut partially into the foam layer 144, disrupting the lower layer 146b, but not disrupting the upper layer 146a, and leaving the skin layer 140 with its upper and lower surfaces 142a, 142b intact. The overall shape of such a tear seam 172 may be varied widely within the scope of the invention as is known to one of skill in the art, but may include a substantially-U-shaped configuration to form a region of the module that will rupture to form an instrument panel flap 174 when the airbag cushion 180 deploys.

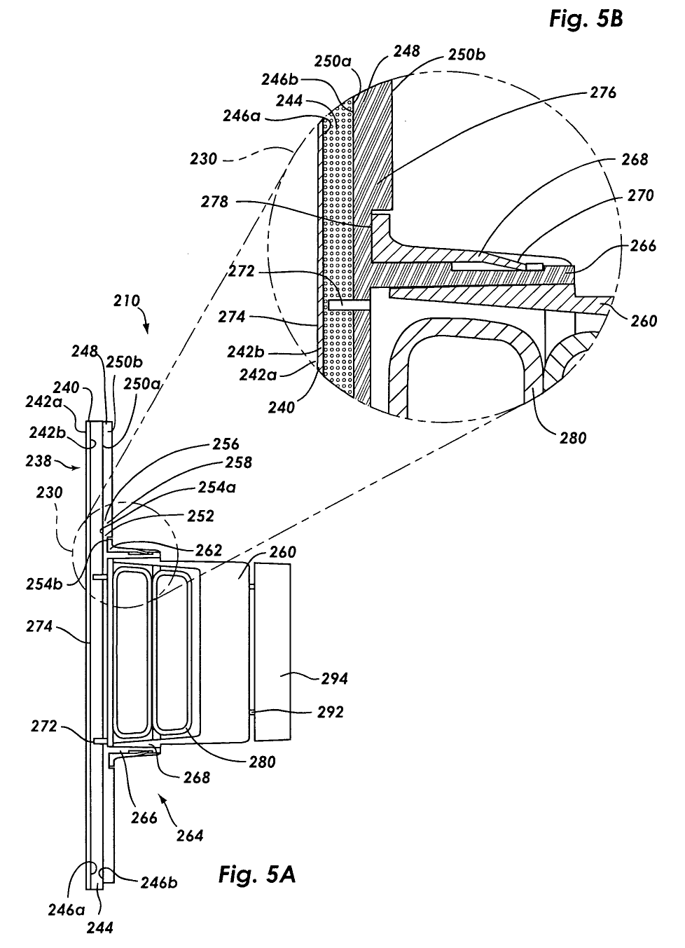

FIG. 5A illustrates still another embodiment of the inflatable airbag module 210 of the invention. FIG. 5A shows a cross-sectional view of this airbag module 210 taken from a perspective similar to that used to produce FIGS. 3A and 4A. More specifically, this view is obtained from a plane such as that defined by line 3A-3A of FIG. 2. As previous FIGS. 3B and 4B, FIG. 5B provides a detailed view of a selected portion of the cross-sectional view of FIG. 5A. The specific section viewed is indicated by the dashed circle 230 present in FIGS. 5A and 5B. The module 210 of FIG. 4A is in many respects similar to modules 10 and 110 of FIGS. 3A-3B and FIGS. 4A-4B, respectively.

The airbag module 210 of FIGS. 5A and 5B first includes a decorative overlay 238, an instrument panel substrate 248, and an airbag module housing 260. In module 210, the instrument panel substrate 248 has been designed to incorporate features found in the module covers 52 and 152 of the previously-described embodiments. Such features include the locking fingers 266, which here extend from the substrate 248, and a module housing contact surface 278. The panel substrate 248 also extends across the space occupied by module covers 52 and 152 in previously-described configurations. As a result, it is the substrate 248 which may be cut to form the tear seam 272.

Module 210 of FIGS. 5A and 5B includes a module housing contact surface 278 at the interface of the lower surface 250b of the instrument panel substrate 248 and the module housing 260. As illustrated in FIGS. 5A and 5B, the contact surface 278 may take the form of an indentation into the substrate 248. This provides an alignment ridge 276 that projects outwardly from the panel 248 to retain the module housing 260 in proper alignment. The upper surface 250a may additionally be configured to receive a decorative overlay 238. As previously described, the decorative overlay 238 such may include a skin layer 240 with an upper surface 242a and a lower surface 242b; and a foam layer 244 with an upper surface 246a and a lower surface 246b.

The substrate panel 248 includes elements of the locks 264 of the module 210, including locking fingers 266 which extend from the substrate panel 248. The resulting configuration allows the housing 260 to be attached to the instrument panel substrate 248 by allowing the locking fingers 266 to enter the locking gates 268 of the housing 260. The locking fingers 266 culminate in locking clips 270 that engage the locking gates 268.

In this embodiment of the module 210 of the invention, the substrate panel 248 may receive a tear seam 272, which may pass completely or partially through the substrate panel 248, and potentially into the foam and skin layers 244, 240. In FIGS. 5A and 5B, the tear seam 272 has been cut completely through the substrate panel 248, disrupting the upper and lower surfaces 250a, 250b, and cut partially into the foam layer 244, disrupting the lower layer 246b, but not disrupting the upper layer 246a, and leaving the skin layer 240 with its upper and lower surfaces 242a, 242b intact. The overall shape of such a tear seam 272 may be varied widely within the scope of the invention as is known to one of skill in the art, but may include a substantially-U-shaped configuration to form a region of the module that will rupture to form an instrument panel flap 274 when the airbag cushion 280 deploys.

The present invention thus provides an inflatable airbag module for protecting a vehicle occupant which may be integrated with a vehicular instrument panel. The invention further provides methods of assembling such an integrated airbag module and instrument panel. According to the invention, the airbag module generally first includes a module cover suitable for being integrated with an instrument panel during the manufacture of the instrument panel. The module cover generally has a substrate surface, an instrument panel adapter, and an airbag housing interlock. The module covers of the invention are integrated with an instrument panel substrate to form a composite substrate surface which may then receive a decorative overlay. In many cases the decorative overlay is a foam and skin overlay that provides an attractive and tactilely pleasing surface suitable for use in the exposed interior of a vehicle. The airbag module of the invention also includes an airbag case portion suited to enclose a folded airbag cushion, and an airbag module cover interlock. The airbag module cover is configured to engage the airbag module cover interlock to attach the module housing to the instrument panel of the invention. According to the invention, such an interlock may utilize snap-fit fasteners to allow simple, predictable, and low-labor assembly of the airbag module cover and instrument panel of the invention.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An inflatable airbag module for protecting a vehicle occupant comprising:
an airbag module cover including a substrate surface, an instrument panel adapter, and an airbag housing interlock, the airbag module cover being adapted to be integrated with an instrument panel substrate to provide a surface suitable for receiving a decorative overlay;
an airbag module housing having an airbag case portion and an airbag module cover interlock portion, the module housing being adapted to be coupled to the airbag module cover; and
an airbag cushion configured to be deployed from the airbag module housing.

2. The inflatable airbag module of claim 1, wherein the substrate surface is configured to receive a skin-and-foam overlay to provide a surface suitable for use in the interior of a vehicle.

3. The inflatable airbag module of claim 1, wherein the instrument panel adapter comprises a radial flange extending from the substrate surface of the airbag module cover.

4. The inflatable airbag module of claim 1, wherein the instrument panel adapter comprises a face of the module cover configured to be attached to an instrument panel.

5. The inflatable airbag module of claim 1, wherein the airbag housing interlock comprises a plurality of locking fingers projecting from the module cover that are configured to extend into the airbag module cover interlock of the airbag module housing to join the module cover and the module housing.

6. The inflatable airbag module of claim 5, wherein the module cover interlock of the airbag module housing is configured to receive the locking fingers of the module cover in a locking fashion.

7. The inflatable airbag module of claim 1, wherein the airbag module cover further includes a tear seam.

8. The inflatable airbag module of claim 7, wherein the tear seam is molded, stamped, or punched into the airbag module cover.

9. The inflatable airbag module of claim 7, wherein the tear seam is laser-scored into the airbag module cover.

10. The inflatable airbag module of claim 1, wherein the airbag cushion is a passenger-side airbag cushion.

11. An airbag module cover for enclosing a passenger airbag module, the airbag module cover having a substrate surface configured to receive a decorative overlay, an instrument panel adapter, and a plurality of locking fingers extending from the cover in a direction substantially opposite the substrate surface.

12. The airbag module cover of claim 11, wherein the substrate surface is configured to receive a skin-and-foam overlay to provide a surface suitable for use in the interior of a vehicle.

13. The airbag module cover of claim 12, wherein the airbag module cover further includes a tear seam.

14. The airbag module cover of claim 13, wherein the tear seam is molded, stamped, or punched into the airbag module cover.

15. The airbag module cover of claim 13, wherein the tear seam is laser scored into the airbag module cover.

16. A vehicular instrument panel having an integral airbag module cover comprising:
a primary dashboard panel having a substrate surface configured to receive a decorative overlay and an airbag module cover adapter; and
an airbag module cover having a substrate surface configured to receive a decorative overlay, an instrument panel adapter, and an airbag housing interlock; wherein the airbag module cover may be integrated with the primary dashboard panel and wherein the substrate surfaces of the resulting assembly may be coated with a decorative overlay.

17. The vehicular instrument panel of claim 16, wherein the airbag module cover adapter of the primary dashboard panel comprises an orifice sized to receive the airbag module cover.

18. The vehicular instrument panel of claim 17, wherein the orifice of the airbag module cover adapter of the primary dashboard panel further comprises an adapter channel having a depth sufficient to allow the airbag module cover to nest into the substrate surface of the primary dashboard panel without substantial protrusion.

19. The vehicular instrument panel of claim 17, wherein integration of the primary dashboard panel and the airbag module cover provides a combination substrate surface that is sufficiently even that the application of a decorative overlay results in a substantially even surface with no obvious seams.

20. The vehicular instrument panel of claim 18, wherein the instrument panel adapter of the airbag module cover comprises a radial flange extending from the substrate surface of the airbag module cover.

21. The vehicular instrument panel of claim 18, wherein the instrument panel adapter of the airbag module cover comprises a face of the module cover configured to be attached to an instrument panel.

22. The vehicular instrument panel of claim 16, wherein the substrate surfaces of the primary dashboard panel and the airbag module cover are configured to receive a skin-and-foam overlay.

23. The vehicular instrument panel of claim 16, wherein the airbag housing interlock comprises a plurality of locking fingers projecting from the airbag module cover that are configured to join the airbag module cover with an airbag module.

24. The vehicular instrument panel of claim 16, wherein the airbag module cover further includes a tear seam.

25. The vehicular instrument panel of claim 24, wherein the tear seam is molded, stamped, or punched into the airbag module cover.

26. The vehicular instrument panel of claim 24, wherein the tear seam is laser scored into the airbag module cover.

27. A vehicular instrument panel having an integral airbag module cover comprising:
a primary dashboard panel having a substrate surface and an airbag module cover adapter, the primary dashboard panel being integrally formed with an airbag module cover having a substrate surface, an instrument panel adapter, and an airbag housing interlock; wherein the substrate surfaces of the primary dashboard panel and airbag module cover may be coated with a decorative overlay.

28. The vehicular instrument panel of claim 27, the primary dashboard panel and the airbag module cover provide a combination substrate surface that is sufficiently even to receive a decorative overlay with a substantially even surface with no obvious seams.

29. The vehicular instrument panel of claim 27, wherein the instrument panel adapter of the airbag module cover comprises a radial flange extending from the substrate surface of the airbag module cover.

30. The vehicular instrument panel of claim 27, wherein the substrate surfaces of the primary dashboard panel and the airbag module cover are configured to receive a skin-and-foam overlay.

31. The vehicular instrument panel of claim 27, wherein the airbag housing interlock comprises a plurality of locking fingers projecting from the airbag module cover that are configured to join the airbag module cover with an airbag module.

32. The vehicular instrument panel of claim 27, wherein the airbag module cover further includes a tear seam.

33. The vehicular instrument panel of claim 32, wherein the tear seam is molded, stamped, or punched into the airbag module cover.

34. The vehicular instrument panel of claim 32, wherein the tear seam is laser scored into the airbag module cover.

35. A vehicular instrument panel having an integral airbag module cover comprising:
a primary dashboard panel having a substrate surface configured to receive a decorative overlay and an airbag module cover portion having an airbag housing interlock; wherein the primary dashboard panel may be connected directly to an airbag module housing, and wherein a portion of the primary dashboard panel covers a portion of the airbag module housing.

36. The vehicular instrument panel of claim 35, wherein the airbag housing interlock of the airbag module cover portion comprises at least one locking finger projecting from the airbag module cover to join the airbag module cover with an airbag module housing.

37. The vehicular instrument panel of claim 35, wherein the airbag module cover further includes a tear seam.

38. The vehicular instrument panel of claim 37, wherein the tear seam is molded, stamped, or punched into the airbag module cover.

39. The vehicular instrument panel of claim 37, wherein the tear seam is laser scored into the airbag module cover.

40. A method of assembling an inflatable airbag module and a vehicular instrument panel comprising the steps of:
providing an instrument panel substrate having a substrate surface adapted to receive a decorative overlay and an airbag module cover adapter for receiving an airbag module cover;
providing an airbag module cover having a substrate surface adapted to receive a decorative overlay, and an airbag housing interlock;
placing the airbag module cover into the instrument panel substrate;
applying a decorative overlay to the instrument panel substrate and the airbag module cover; and
attaching an airbag module to the airbag module cover. 28. The method of assembling an inflatable airbag module and a vehicular instrument panel of claim 27, wherein the substrate surfaces of the instrument panel substrate and the airbag module cover are configured to receive a skin-and-foam decorative overlay.

41. The method of assembling an inflatable airbag module and a vehicular instrument panel of claim 40, wherein the airbag module cover adapter comprises an area of the instrument panel substrate recessed to accommodate the airbag module cover.

42. The method of assembling an inflatable airbag module and a vehicular instrument panel of claim 40, wherein the airbag module cover further includes an instrument panel adapter.

43. The method of assembling an inflatable airbag module and a vehicular instrument panel of claim 42, wherein the instrument panel adapter comprises a radial flange extending from the substrate surface of the airbag module cover.

44. The method of assembling an inflatable airbag module and a vehicular instrument panel of claim 42, wherein the instrument panel adapter comprises a face of the module cover configured to be attached to an instrument panel.

45. The method of assembling an inflatable airbag module and a vehicular instrument panel of claim 40, wherein the airbag housing interlock comprises a plurality of locking fingers projecting from the module cover that are configured to extend into the airbag module cover interlock of the airbag module housing to join the module cover and the module housing.

46. The method of assembling an inflatable airbag module and a vehicular instrument panel of claim 45, wherein the module cover interlock of the airbag module housing is configured to receive the locking fingers of the module cover in a locking fashion.

47. The method of assembling an inflatable airbag module and a vehicular instrument panel of claim 40, wherein the airbag module cover further includes a tear seam.

48. The method of assembling an inflatable airbag module and a vehicular instrument panel of claim 47, wherein the tear seam is molded, stamped, or punched into the airbag module cover.

49. The method of assembling an inflatable airbag module and a vehicular instrument panel of claim 47, wherein the tear seam is laser-scored into the airbag module cover.

50. The method of assembling an inflatable airbag module and a vehicular instrument panel of claim 40, wherein the airbag cushion is a passenger-side airbag cushion.
